(19) United States
(12) Patent Application Publication
(10) Pub. No.: US 2014/0258973 A1
(43) Pub. Date: Sep. 11, 2014

(54) Systems And Methods For Automatically Generating Applications

(71) Applicant: CHIDOPI CO., LTD., Taipei City (TW)

(72) Inventor: Jason Hung, Taoyuan County (TW)

(73) Assignee: CHIDOPI CO., LTD., Taipei City (TW)

(21) Appl. No.: 13/792,451

(22) Filed: Mar. 11, 2013

(51) Int. Cl. G06F 9/44

(52) U.S. Cl. CPC G06F 8/34
USPC 717/109

(57) ABSTRACT

Systems and methods for automatically generating applications are provided. The system includes an application design platform and at least one user device. The application design platform has a visual editing environment for designing applications. The user device edits configuration data and material data corresponding to a subject application using the visual editing environment. The application design platform determines whether the editing of the subject application is completed. When the editing of the subject application is completed, the application design platform reads the configuration data corresponding to the subject application and obtains the material data corresponding to the subject application, and packs the configuration data and the material data into at least one application package for at least one operating system platform.

### BACKGROUND OF THE INVENTION

1. Field of the Invention

The disclosure relates generally to systems and methods for automatically generating applications (APPs), and, more particularly to systems and methods that can edit related data for an application, and automatically pack the data corresponding to the application into at least one application package corresponding to at least one operating system platform.

2. Description of the Related Art

Recently, handheld devices, such as smart phones, have become more and more advanced and multifunctional. Due to increased convenience and functions of the devices, these devices have become necessities of life, and these functions have been more frequently used.

Since the operating system platform which these device are belonged to allows public to develop applications, or called APPs to be used in these devices, a large amount of applications with a variety of functions are available on the Internet. Users can download related applications to their smart phones for use according to their interests and requirements.

Conventionally, in the procedure of design and development of applications for handheld devices, designers must first conceive functions and operation scenarios of an application. Since the designers may not have the techniques for programming, the designers must communicate related details with the software engineers, and ask the software engineers to perform the program writings corresponding to the application. In general, the design for an application may be completed in several times of communications and corrections between the designer and the software engineers. The conventional procedure requires a high human resource cost, and is time-consuming.

Further, since the handheld devices may have several operating system platforms, such as the iOS platform or Android platform, the designer must develop different versions of applications for different operating system platforms. When the number of operating system platforms increases, the related cost for development and maintenance of applications may be significantly increased.

### BRIEF SUMMARY OF THE INVENTION

Systems and methods for automatically generating applications are provided.

An embodiment of a system for automatically generating applications comprises an application design platform and at least one user device. The application design platform has a visual editing environment for designing applications. The user device connects to the application design platform via a network, and edits configuration data and material data corresponding to a subject application using the visual editing environment. The application design platform determines whether the editing of the subject application is completed. When the editing of the subject application is completed, the application design platform reads the configuration data corresponding to the subject application and obtains the material data corresponding to the subject application, and packs the configuration data and the material data into at least one application package for at least one operating system platform.

In an embodiment of a method for automatically generating applications, a user device connects to an application design platform via a network, wherein the application design platform has a visual editing environment for designing applications. Then, the user device edits configuration data and material data corresponding to a subject application using the visual editing environment. The application design platform determines whether the editing of the subject application is completed. When the editing of the subject application is completed, the application design platform reads the configuration data corresponding to the subject application and obtains the material data corresponding to the subject application, and packs the configuration data and the material data into at least one application package for at least one operating system platform.

In some embodiments, after the at least one application package corresponding to the subject application is generated, the application design platform further transmits a notification to the user device for notifying the user device to download the at least one application package.

In some embodiments, the application design platform periodically checks whether the editing of the subject application is completed. In some embodiments, when the editing of the subject application is completed, the user device transmits a completion instruction corresponding to the subject application to the application design platform, and after the application design platform receives the completion instruction, the application design platform knows the editing of the subject application is completed.

In some embodiments, the application design platform comprises at least one PERL program code for corresponding to one of the at least one operating system platform, wherein one of the at least one PERL program code packs the configuration data and the material data into the application package corresponding to the operating system platform. In some embodiments, the user device can further edit an output platform setting corresponding to the subject application. The output platform setting comprises at least one specific operating system platform among the at least one operating system platform. The application design platform can pack the configuration data and the material data into the application package corresponding to the at least one specific operating system platform according to the output platform setting.

In some embodiments, the user device can further edit media interaction data corresponding to the subject application, and the application design platform generates a media interaction engine in the application package according to the media interaction data, wherein when the application package executes, the media interaction engine controls media interaction operations.

In some embodiments, the user device can further edit game data corresponding to the subject application, and the application design platform generates a game engine in the application package according to the game data, wherein when the application package executes, the game engine controls game actions corresponding to a game.

In some embodiments, the application package can comprise a native component library and execution procedures, a multi-media interpreter corresponding to the at least one operating system platform, and an application interactive language package corresponding to the configuration data and the material data, wherein when the application package executes, the multi-media interpreter reads and interprets the application interactive language package, and executes according to the native component library and the execution procedures.

Methods for automatically generating applications may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for automatically generating applications of the invention;

FIG. 2 is a schematic diagram illustrating an embodiment of an application design platform of the invention;

FIG. 3 is a schematic diagram illustrating an embodiment of an application interactive language package of the invention;

FIG. 4 is a schematic diagram illustrating an embodiment of an application package of the invention;

FIG. 5 is a flowchart of an embodiment of a method for automatically generating applications of the invention; and

FIG. 6 is a flowchart of another embodiment of a method for automatically generating applications of the invention.

### DETAILED DESCRIPTION OF THE INVENTION

Systems and methods for automatically generating applications are provided.

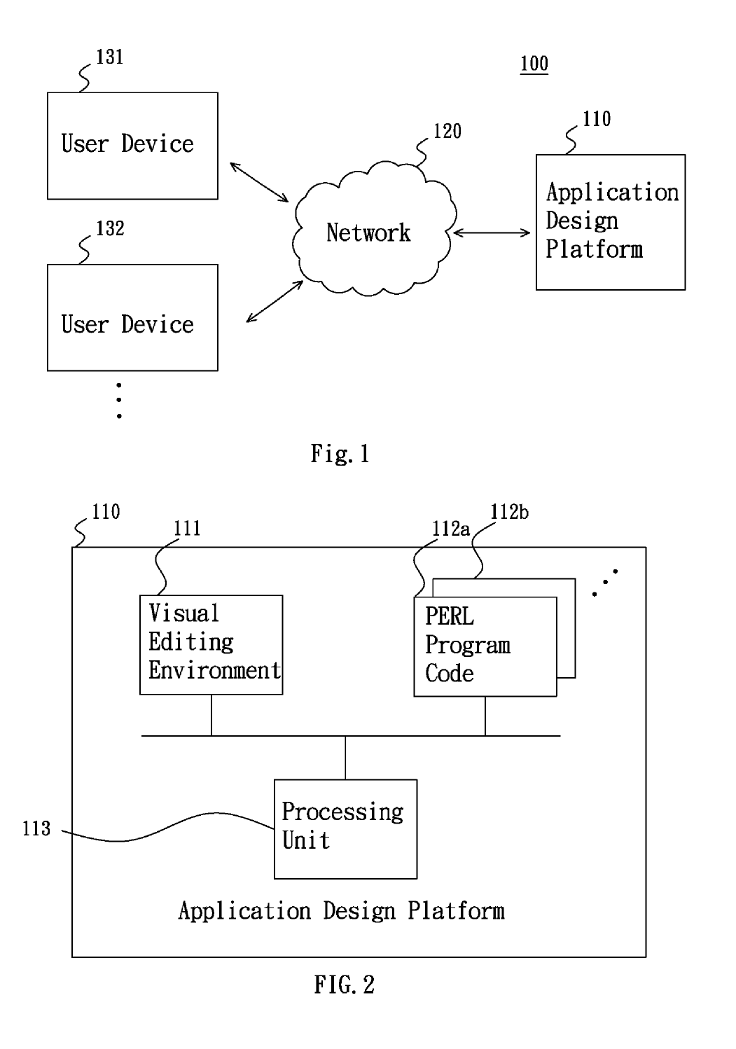

FIG. 1 is a schematic diagram illustrating an embodiment of a system for automatically generating applications of the invention. The system for automatically generating applications 100 can comprise at least one user device (131, 132) and an application design platform 110. It is understood that, the user device can be any electronic device having network connection capabilities, such as a personal computer, or a portable device, such as a mobile phone, a smart phone, a PDA (Personal Digital Assistant), a GPS (Global Positioning System), or a notebook. The respective user device can connect to the application design platform 110 via a network 120, such as the Internet, for performing design operations for applications.

FIG. 2 is a schematic diagram illustrating an embodiment of an application design platform of the invention. As shown in FIG. 2, the application design platform 110 comprises a visual editing environment 111, at least one PERL program code (112a, 112b), and a processing unit 113. The visual editing environment 111 has a graphical interface. The graphical interface can comprise a plurality of predefined components, such as graphical components, touch-sensitive components, and APP action components. Users can directly drag these components to complete the design of an application, such as the editing operations corresponding to the configuration data, the material data, and/or the output platform setting. Each PERL program code can correspond to an operating system, such as the iOS platform, the Android platform, the Windows platform, or any operating system for personal computers. Based on the operating system platform designated in the output platform setting, the respective PERL program code can pack the configuration data and the material data corresponding to the application into an application package corresponding to the designated operating system platform. The processing unit 113 can control the operations of related hardware, firmware, and/or software in the application design platform 110, and related details are discussed latter.

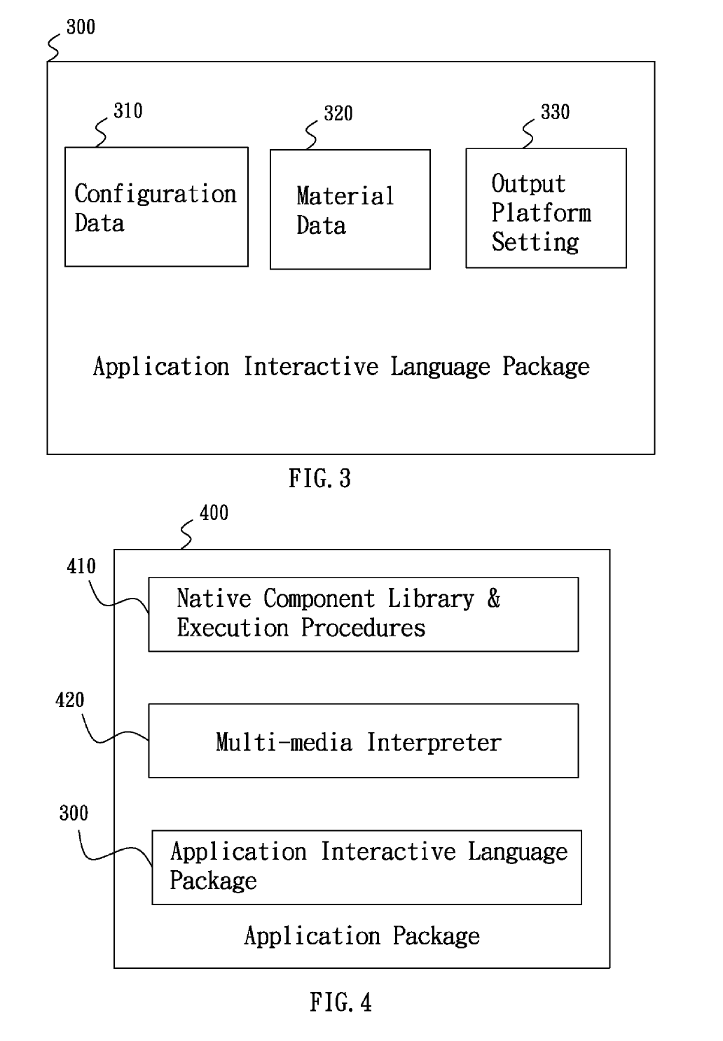

As described, users can edit the configuration data 310, the material data 320, and the output platform 330 corresponding to a subject application in the visual editing environment 111 provided by the application design platform 110. The application design platform 110 can pack the edited data into an application interactive language package 300, as shown in FIG. 3. It is understood that, in some embodiments, users can further edit media interaction data corresponding to the subject application in the visual editing environment 111 provided by the application design platform 110. The application design platform 110 can generate a media interaction engine (not shown in FIG. 3) in the application interactive language package 300 according to the media interaction data, wherein when the subject application executes, the media interaction engine can control the media interaction operations. Further, in some embodiments, users can further edit game data corresponding to the subject application in the visual editing environment 111 provided by the application design platform 110. The application design platform 110 can generate a game engine (not shown in FIG. 3) in the application interactive language package 300 according to the game data, wherein when the subject application executes, the game engine can control the game actions corresponding to a game.

After the application interactive language package 300 is generated, the PERL program code packs the application interactive language package 300 into an application package for the corresponding operating system platform. As shown in FIG. 4, the application package 400 can comprise a native component library and execution procedures 410, a multi-media interpreter 420 corresponding to the operating system platform, and the application interactive language package 300, wherein when the application package 400 executes, the multi-media interpreter 420 reads and interprets the application interactive language package 300, and executes according to the native component library and the execution procedures 410.

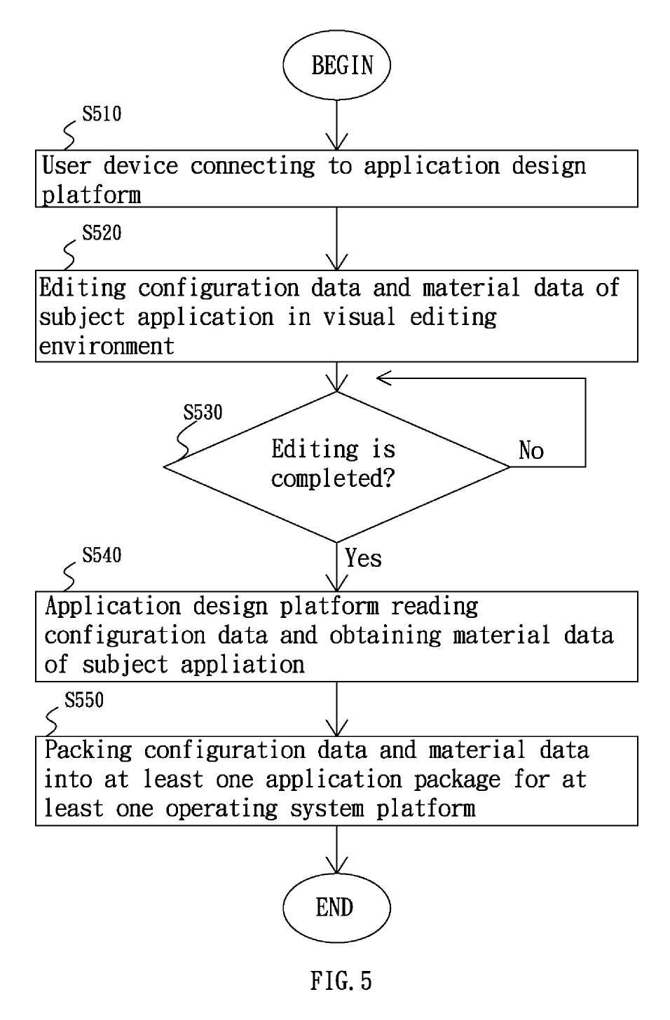

FIG. 5 is a flowchart of an embodiment of a method for automatically generating applications of the invention.

In step S510, a user device connects to an application design platform via a network, such as the Internet. It is understood that, the user device can be any electronic device having network connection capabilities, such as a personal computer, or a portable device, such as a mobile phone, a smart phone, a PDA, a GPS, or a notebook. The application design platform can have a visual editing environment for designing applications. The visual editing environment has a graphical interface. The graphical interface can comprise a plurality of predefined components, such as graphical components, touch-sensitive components, and APP action components. In step S520, the user device edits configuration data and material data corresponding to a subject application in the visual editing environment provided by the application design platform. As described, the graphical interface can comprise a plurality of predefined components. Users can directly drag these components to complete the design of an application. In step S530, the application design platform determines whether the editing of the subject application is completed. It is understood that, in some embodiments, the application design platform can periodically check whether the editing of the subject application is completed. Further, in some embodiments, when the editing of the subject application is completed, the user device can transmit a completion instruction corresponding to the subject application to the application design platform. After the application design platform receives the completion instruction, the application design platform knows the editing of the subject application is completed. If the editing of the subject application is not completed (No in step S530), the procedure remains at step S530. If the editing of the subject application is completed (Yes in step S530), in step S540, the application design platform reads the configuration data corresponding to the subject application and obtains the material data corresponding to the subject application, and in step S550, packs the configuration data and the material data into at least one application package for at least one operating system platform. It is understood that, in some embodiments, after the at least one application package corresponding to the subject application is generated, the application design platform can transmit a notification to the user device for notifying the user device to download the at least one application package.

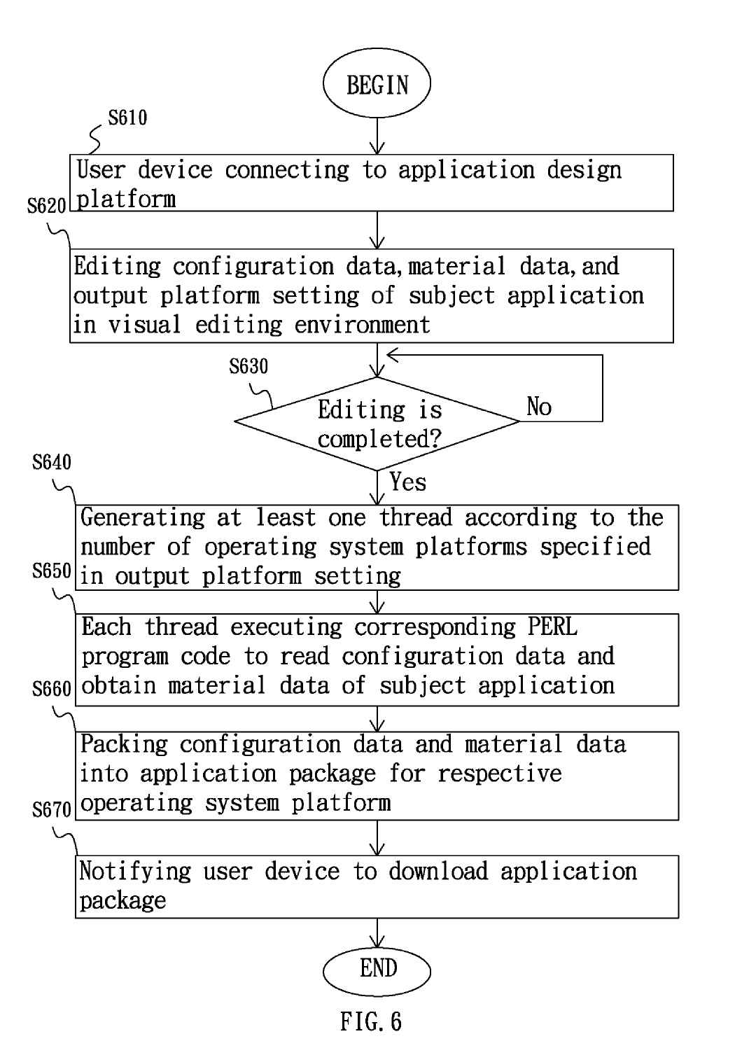

FIG. 6 is a flowchart of another embodiment of a method for automatically generating applications of the invention.

In step S610, a user device connects to an application design platform via a network, such as the Internet. Similarly, the user device can be any electronic device having network connection capabilities, such as a personal computer, or a portable device, such as a mobile phone, a smart phone, a PDA, a GPS, or a notebook. The application design platform can have a visual editing environment for designing applications. The visual editing environment has a graphical interface. The graphical interface can comprise a plurality of predefined components, such as graphical components, touch-sensitive components, and APP action components. In step S620, the user device edits configuration data, material data, and an output platform setting corresponding to a subject application in the visual editing environment provided by the application design platform. Specifically, the versions corresponding to different operating systems that the subject application is expected to output can be specified in the output platform setting. As described, the graphical interface can comprise a plurality of predefined components. Users can directly drag these components to complete the design of an application. Additionally, in some embodiments, users can further edit media interaction data corresponding to the subject application in the visual editing environment provided by the application design platform. The application design platform can generate a media interaction engine according to the media interaction data, wherein when the subject application executes, the media interaction engine can control the media interaction operations. Further, in some embodiments, users can further edit game data corresponding to the subject application in the visual editing environment provided by the application design platform. The application design platform can generate a game engine according to the game data, wherein when the subject application executes, the game engine can control the game actions corresponding to a game. It is understood that, after the editing of the subject application is completed, related editing data, such as the configuration data, the material data, the output platform setting, media interaction engine, and/or the game engine can be packed into an application interactive language package. In step S630, the application design platform determines whether the editing of the subject application is completed. Similarly, in some embodiments, the application design platform can periodically check whether the editing of the subject application is completed. Further, in some embodiments, when the editing of the subject application is completed, the user device can transmit a completion instruction corresponding to the subject application to the application design platform. After the application design platform receives the completion instruction, the application design platform knows the editing of the subject application is completed. If the editing of the subject application is not completed (No in step S630), the procedure remains at step S630. If the editing of the subject application is completed (Yes in step S630), in step S640, at least one thread is generated according to the number of the operating system platform specified in the output platform setting, and in step S650, each thread respectively executes the PERL program code corresponding to the respective operating system platform to read the configuration data corresponding to the subject application and obtain the material data corresponding to the subject application. Then, in step S660, the configuration data and the material data is packed into the application package for the corresponding operating system platform. In step S670, the application design platform transmits a notification to the user device for notifying the user device to download the application package.

It is noted that again, in the present application, the application package can comprise a native component library and execution procedures, a multi-media interpreter corresponding to the operating system platform, and an application interactive language package. When the application package executes, the multi-media interpreter can read and interpret the application interactive language package, and execute according to the native component library and the execution procedures.

Therefore, the systems and methods for automatically generating applications of the present invention can edit applications in a visualized manner, and related editing data can be automatically packed into application packages corresponding to different operating system platforms, thereby saving related costs, such manpower and time resources for development and maintenance of applications.

Methods for automatically generating applications, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A system for automatically generating applications, comprising:
an application design platform having a visual editing environment for designing applications; and
a user device connecting to the application design platform via a network, editing configuration data and material data corresponding to a subject application using the visual editing environment,
wherein the application design platform determines whether the editing of the subject application is completed, when the editing of the subject application is completed, the application design platform reads the configuration data corresponding to the subject application and obtains the material data corresponding to the subject application, and packs the configuration data and the material data into at least one application package for at least one operating system platform.

2. The system of claim 1, wherein after the at least one application package corresponding to the subject application is generated, the application design platform further transmits a notification to the user device for notifying the user device to download the at least one application package

3. The system of claim 1, wherein the application design platform periodically checks whether the editing of the subject application is completed.

4. The system of claim 1, wherein when the editing of the subject application is completed, the user device transmits a completion instruction corresponding to the subject application to the application design platform, and after the application design platform receives the completion instruction, the application design platform knows the editing of the subject application is completed.

5. The system of claim 1, wherein the application design platform comprises at least one PERL program code for corresponding to one of the at least one operating system platform, wherein one of the at least one PERL program code packs the configuration data and the material data into the application package corresponding to the operating system platform.

6. The system of claim 5, wherein the user device further edits an output platform setting corresponding to the subject application, wherein the output platform setting comprises at least one specific operating system platform among the at least one operating system platform, and the application design platform packs the configuration data and the material data into the application package corresponding to the at least one specific operating system platform according to the output platform setting.

7. The system of claim 1, wherein the user device further edits media interaction data corresponding to the subject application, and the application design platform generates a media interaction engine in the application package according to the media interaction data, wherein when the application package executes, the media interaction engine controls media interaction operations.

8. The system of claim 1, wherein the user device further edits game data corresponding to the subject application, and the application design platform generates a game engine in the application package according to the game data, wherein when the application package executes, the game engine controls game actions corresponding to a game.

9. The system of claim 1, wherein the application package comprises a native component library and execution procedures, a multi-media interpreter corresponding to the at least one operating system platform, and an application interactive language package corresponding to the configuration data and the material data, wherein when the application package executes, the multi-media interpreter reads and interprets the application interactive language package, and executes according to the native component library and the execution procedures.

10. A method for automatically generating applications, comprising:
connecting to an application design platform via a network by a user device, wherein the application design platform having a visual editing environment for designing applications;
editing configuration data and material data corresponding to a subject application using the visual editing environment by the user device;
determines whether the editing of the subject application is completed by the application design platform; and
when the editing of the subject application is completed, reading the configuration data corresponding to the subject application and obtaining the material data corresponding to the subject application, and packing the configuration data and the material data into at least one application package for at least one operating system platform by the application design platform.

11. The method of claim 10, wherein after the at least one application package corresponding to the subject application is generated, the application design platform further transmits a notification to the user device for notifying the user device to download the at least one application package

12. The method of claim 10, wherein the application design platform periodically checks whether the editing of the subject application is completed.

13. The method of claim 10, wherein when the editing of the subject application is completed, the user device transmits a completion instruction corresponding to the subject application to the application design platform, and after the application design platform receives the completion instruction, the application design platform knows the editing of the subject application is completed.

14. The method of claim 10, wherein the application design platform comprises at least one PERL program code for corresponding to one of the at least one operating system platform, wherein one of the at least one PERL program code packs the configuration data and the material data into the application package corresponding to the operating system platform.

15. The method of claim 14, further comprising editing an output platform setting corresponding to the subject application by the user device, wherein the output platform setting comprises at least one specific operating system platform among the at least one operating system platform, and the application design platform packs the configuration data and the material data into the application package corresponding to the at least one specific operating system platform according to the output platform setting.

16. The method of claim 10, further comprising editing media interaction data corresponding to the subject application by the user device, and the application design platform generates a media interaction engine in the application package according to the media interaction data, wherein when the application package executes, the media interaction engine controls media interaction operations.

17. The method of claim 10, further comprising editing game data corresponding to the subject application, and the application design platform generates a game engine in the application package according to the game data, wherein when the application package executes, the game engine controls game actions corresponding to a game.

18. The method of claim 10, wherein the application package comprises a native component library and execution procedures, a multi-media interpreter corresponding to the at least one operating system platform, and an application interactive language package corresponding to the configuration data and the material data, wherein when the application package executes, the multi-media interpreter reads and interprets the application interactive language package, and executes according to the native component library and the execution procedures.

19. A machine-readable storage medium comprising a computer program, which, when executed, causes a device to perform a method for automatically generating applications, wherein the method comprises:
receiving a connection from a user device via a network by an application design platform, wherein the application design platform having a visual editing environment for designing applications;
editing configuration data and material data corresponding to a subject application using the visual editing environment by the user device;
determines whether the editing of the subject application is completed by the application design platform; and
when the editing of the subject application is completed, reading the configuration data corresponding to the subject application and obtaining the material data corresponding to the subject application, and packing the configuration data and the material data into at least one application package for at least one operating system platform by the application design platform.
